(19) United States
(12) Patent Application Publication
(10) Pub. No.: US 2020/0322228 A1
(43) Pub. Date: Oct. 8, 2020

(54) Method and System for Instantiating One or More Services on Customer Premises Equipment

(71) Applicant: CenturyLink Intellectual Property LLC, Broomfield, CO (US)

(72) Inventor: Zubin Ingah, Centennial, CO (US)

(21) Appl. No.: 16/439,905

(22) Filed: Jun. 13, 2019

Related U.S. Application Data
(60) Provisional application No. 62/829,787, filed on Apr. 5, 2019.

(51) Int. Cl. H04L 12/24

(52) U.S. Cl. CPC H04L 41/18; H04L 41/20; H04L 41/22; H04L 41/082

(57) ABSTRACT

Novel tools and techniques are provided for implementing one or more services within a customer premises, and, more particularly, to methods, systems, and apparatuses for implementing one or more services on customer premises equipment contained within the customer premises. In some embodiments, a computing system might receive a first identifier associated with at least one service and might access a portal associated with the first identifier. The portal might receive a second identifier associated with a user and, in response to the user providing the second identifier via the portal, the computing system might send, via the portal, one or more updates to the at least one customer premises equipment, based at least in part on one or more of the first identifier associated with the at least one service and/or the second identifier associated with the user.

### CROSS-REFERENCES TO RELATED APPLICATIONS

This application claims priority to U.S. Patent Application Ser. No. 62/829,787 (the “'787 Application”), filed Apr. 5, 2019 by Zubin Ingah (attorney docket no. 1529-US-P1), entitled, “Method and System for Instantiating one or more Services on Customer Premises Equipment,” the disclosure of which is incorporated herein by reference in its entirety for all purposes.

The respective disclosures of these applications/patents (which this document refers to collectively as the “Related Applications”) are incorporated herein by reference in their entirety for all purposes.

### COPYRIGHT STATEMENT

A portion of the disclosure of this patent document contains material that is subject to copyright protection. The copyright owner has no objection to the facsimile reproduction by anyone of the patent document or the patent disclosure as it appears in the Patent and Trademark Office patent file or records, but otherwise reserves all copyright rights whatsoever.

### FIELD

The present disclosure relates, in general, to methods, systems, and apparatuses for implementing one or more services within a customer premises, and, more particularly, to methods, systems, and apparatuses for implementing one or more services on customer premises equipment contained within the customer premises.

### BACKGROUND

Traditionally, when customer premises equipment (“CPE”) is delivered to and installed at a customer premises, the CPE is preprogrammed with and/or dedicated to one or more services or functionalities. Neither the user of the CPE nor the service provider associated with the CPE can easily reprogram the CPE and/or instantiate new services on the CPE.

Hence, there is a need for more robust and scalable solutions for implementing one or more services within a customer premises, and, more particularly, to methods, systems, and apparatuses for implementing one or more services on customer premises equipment contained within the customer premises.

### BRIEF DESCRIPTION OF THE DRAWINGS

A further understanding of the nature and advantages of particular embodiments may be realized by reference to the remaining portions of the specification and the drawings, in which like reference numerals are used to refer to similar components. In some instances, a sub-label is associated with a reference numeral to denote one of multiple similar components. When reference is made to a reference numeral without specification to an existing sub-label, it is intended to refer to all such multiple similar components.

FIG. 1 is a schematic diagram illustrating a system for implementing one or more services within a customer premises, in accordance with various embodiments.

FIG. 2 is a schematic diagram of a portal for implementing one or more services within a customer premises, in accordance with various embodiments.

FIGS. 3A and 3B are schematic diagrams illustrating examples of using one or more identifiers to access a portal for implementing one or more services within a customer premises, in accordance with various embodiments.

FIGS. 4A and 4B are flow diagrams illustrating a method for implementing one or more services within a customer premises, in accordance with various embodiments.

FIG. 5 is a block diagram illustrating an exemplary computer or system hardware architecture, in accordance with various embodiments.

FIG. 6 is a block diagram illustrating a networked system of computers, computing systems, or system hardware architecture, which can be used in accordance with various embodiments.

### DETAILED DESCRIPTION OF CERTAIN EMBODIMENTS

### Overview

Various embodiments provide tools and techniques implementing one or more services within a customer premises, and, more particularly, to methods, systems, and apparatuses for implementing one or more services on customer premises equipment (“CPE”) contained within the customer premises.

In various embodiments, a computing system might receive a first identifier associated with at least one service. In some embodiments, the computing system might access a portal associated with the first identifier that is associated with the at least one service. The computing system may then receive via the portal a second identifier associated with a user who is requesting, from a service provider, service via one or more of at least one CPE or a user device. The computing system may verify that the second identifier is associated with the user. According to some embodiments, in response to the user providing the second identifier via the portal and the portal verifying the provided second identifier, the computing system may send, via the portal, one or more updates to the at least one customer premises equipment, based at least in part on one or more of the first identifier associated with the at least one service and the second identifier associated with the user.

The various embodiments provide advantages over conventional deployment of one or more services in that the embodiments simplify the process for installing CPE and instantiating one or more services on the CPE. The embodiments shorten the time to provision or turn up a new service once CPE has been installed and powered up. Further, service providers can easily verify whether CPE has been installed at the correct customer premises. In this manner, installing CPE and instantiating one or more services on CPE may be performed in a significantly shorter time compared with traditional CPE installation and service instantiation.

These and other features and advantages of the various embodiments are described in detail below with respect to the figures.

The following detailed description illustrates a few exemplary embodiments in further detail to enable one of skill in the art to practice such embodiments. The described examples are provided for illustrative purposes and are not intended to limit the scope of the invention.

In the following description, for the purposes of explanation, numerous specific details are set forth in order to provide a thorough understanding of the described embodiments. It will be apparent to one skilled in the art, however, that other embodiments of the present invention may be practiced without some of these specific details. In other instances, certain structures and devices are shown in block diagram form. Several embodiments are described herein, and while various features are ascribed to different embodiments, it should be appreciated that the features described with respect to one embodiment may be incorporated with other embodiments as well. By the same token, however, no single feature or features of any described embodiment should be considered essential to every embodiment of the invention, as other embodiments of the invention may omit such features.

Unless otherwise indicated, all numbers used herein to express quantities, dimensions, and so forth used should be understood as being modified in all instances by the term “about.” In this application, the use of the singular includes the plural unless specifically stated otherwise, and use of the terms “and” and “or” means “and/or” unless otherwise indicated. Moreover, the use of the term “including,” as well as other forms, such as “includes” and “included,” should be considered non-exclusive. Also, terms such as “element” or “component” encompass both elements and components comprising one unit and elements and components that comprise more than one unit, unless specifically stated otherwise.

Various embodiments described herein, while embodying (in some cases) software products, computer-performed methods, and/or computer systems, represent tangible, concrete improvements to existing technological areas, including, without limitation, CPE technology, service instantiation technology, networking technology, communication technology, and/or the like. In other aspects, certain embodiments, can improve the functioning of user equipment or systems themselves (e.g., CPE, networking systems, communication systems, etc.), for example, by sending, with the computing system and via the portal, one or more updates to the at least one customer premises equipment, based at least in part on one or more of the first identifier associated with the at least one service and the second identifier associated with the user; and/or the like. In particular, to the extent any abstract concepts are present in the various embodiments, those concepts can be implemented as described herein by devices, software, systems, and methods that involve specific novel functionality (e.g., steps or operations), such as, sending, with the computing system and via the portal, one or more updates to the at least one customer premises equipment, based at least in part on one or more of the first identifier associated with the at least one service and the second identifier associated with the user, and/or the like, to name a few examples, that extend beyond mere conventional computer processing operations. These functionalities can produce tangible results outside of the implementing computer system, including, merely by way of example, optimized and efficient integration of one or more services on CPE, or the like.

In an aspect, a method might comprise receiving, with a computing system, a first identifier associated with at least one service; accessing, with the computing system, a portal associated with the first identifier that is associated with the at least one service; receiving, with the computing system and via the portal, a second identifier associated with a user who is requesting, from a service provider, service via one or more of at least one CPE or a user device; verifying, with the computing system and via the portal, the second identifier associated with the user; and in response to the user providing the second identifier via the portal and the portal verifying the provided second identifier, sending, with the computing system and via the portal, one or more updates to the at least one customer premises equipment, based at least in part on one or more of the first identifier associated with the at least one service and the second identifier associated with the user.

In some cases, the at least one service might include, without limitation, at least one of one or more services associated with a dedicated customer premises equipment, one or more video services, one or more wireless services, one or more services associated with one or more virtual machines, one or more over the top services, updates associated with the one or more services associated with the dedicated customer premises equipment, updates associated with the one or more video services, updates associated with the one or more wireless services, updates associated with the one or more services associated with the one or more virtual machines, or updates associated with the one or more over the top services, and/or the like.

In some embodiments, the CPE might include, without limitation, one of a modem, a router, an optical network terminal, a set-top box (“STB”), a gateway, a media player, a gaming console, a camera, a sensor, a thermostat, a desktop computer, or a laptop computer, and/or the like. The modem might include at least one of a digital subscriber line modem, a G.fast modem, or a cable modem, and/or the like. The set-top box might include an Internet protocol television set-top box, or an over-the-top set-top box, and/or the like. The gateway might include at least one of a residential gateway, a business gateway, a pay-per-view gateway, or a security gateway, and/or the like.

In various other embodiments, CPE might be a universal CPE which is configured to adapt to perform functionalities associated with a dedicated CPE. In other words, the universal CPE may be unassociated with any dedicated device (e.g., gateway, firewall, STB, etc.) until one or more functionalities associated with a dedicated device are downloaded onto the universal CPE. Once the one or more functionalities are downloaded onto the universal CPE, the universal CPE may adapt to perform as one of a modem, a router, an optical network terminal, a STB, a gateway, a media player, a gaming console, a camera, a sensor, a thermostat, a desktop computer, or a laptop computer, and/or the like, based on the downloaded one or more functionalities. In some cases, the universal CPE may function as two or more of a modem, a router, a firewall, an optical network terminal, a set-top box, a wireless access point, a gateway, a media player, a gaming console, a camera, a sensor, a thermostat, a desktop computer, or a laptop computer, and/or the like.

According to some embodiments, the portal may be at least one of a software application or a website.

In some cases, the method might further include receiving, with the computing system and via the portal, user input selecting the one or more updates to send to the at least one customer premises equipment. The user input may be received via a user device and/or via one or more CPE located at a customer premises.

In some instances, the method might further comprise determining, with the computing system and via the portal, one or more available updates based on the first identifier associated with the at least one service; and displaying, with the computing system and via the portal, one or more available updates to the user.

In some embodiments, the method might additionally include, without limitation, receiving, with the computing system and via the portal, user input indicating the one or more updates to push to the at least one customer premises equipment, wherein the one or more updates are associated with a location of the at least one customer premises equipment; receiving, with the computing system, the location of the at least one customer premises equipment; and based on the location of the at least one customer premises equipment, sending, with the computing system and to the at least one customer premises equipment, the one or more updates associated with the location of the at least one customer premises equipment. When a user interacts with the portal, a user may select a location to send one or more services. The computing system may then determine whether there is CPE that is compatible with the one or more services at the one or more locations and send the one or more services/service updates to the compatible CPE at the corresponding location.

In some cases, the method might further include determining, with the computing system, a location associated with the at least one CPE; and based on a determination of the location associated with the at least one CPE, determining, with the computing system, one or more communication channels to autonomously send the one or more updates. For example, a service provider might prioritize its own communication paths over a third party's communication path.

In various instances, the method might additionally include determining, with the computing system, a location associated with the at least one CPE; and based on a determination of the location associated with the at least one CPE, determining, with the computing system, one or more times to autonomously send the one or more updates. In weak or slow service areas, one or more updates or services may be pushed to CPE during non-peak network traffic times to avoid overloading one or more communications paths.

In various embodiments, the first identifier might include, without limitation, at least one of a unique identifier, a QR code, a bar code, a serial number, a number sequence, a letter sequence, or a number and letter sequence, and/or the like. The second identifier might include, without limitation, one or more of a unique identifier associated with the user, a QR code associated with the user, a serial number associated with the user, a number sequence associated with the user, a letter sequence associated with the user, a number and letter sequence associated with the user, a username associated with the user, a password associated with the user, or an Internet protocol address associated with the user, and/or the like.

In various cases, the one or more updates might include, without limitation, at least one of one or more functionalities associated with a dedicated CPE, one or more functionalities associated with one or more video services, one or more functionalities associated with one or more wireless services, one or more functionalities associated with one or more virtual machines, one or more functionalities associated with over the top services, updates associated with the one or more functionalities associated with the dedicated CPE, updates associated with the one or more functionalities associated with the one or more video services, updates associated with the one or more functionalities associated with the one or more wireless services, updates associated with the one or more functionalities associated with the one or more virtual machines, or updates associated with the one or more functionalities associated with the over the top services, and/or the like.

In some instances, the method might further include receiving, with the computing system, a third identifier associated with the at least one CPE; and determining, with the computing system, one or more available updates based on the third identifier associated with the CPE. The third identifier might include, without limitation, one or more of a unique, a QR code, a bar code, a serial number, a number sequence, a letter sequence, a number and letter sequence, or an Internet protocol address associated with the CPE, and/or the like.

In some embodiments, the method might additionally include determining, with the computing system, a location of the at least one CPE. The location of the at least one CPE may be determined when the computing system detects the at least one CPE attempting to connect to a network or when the computing system detects the at least CPE has been powered up. The method may then include sending, with the computing system, a request to a user device to confirm that the at least one CPE is disposed at the location. Sending, with the computing system and via the portal, one or more updates to each of the at least one CPE may include sending, with the computing system, the one or more updates to the at least one CPE, in response to receiving a confirmation of the location associated with the at least one CPE. In this manner, a service provider may confirm that CPE is installed at the correct customer premises.

In some instances, the request may be sent via at least one of an email, a text message, or a voice call, and/or the like. The user device may include, without limitation, at least one of a desktop computer associated with the user, a laptop computer associated with the user, a tablet computer associated with the user, a smart phone associated with the user, a cellphone associated with the user, a personal digital assistant associated with the user, a remote-control device associated with the user, or a portable gaming device associated with the user, and/or the like.

In another aspect, an apparatus might comprise at least one processor and a non-transitory computer readable medium communicatively coupled to the at least one processor. The non-transitory computer readable medium might have stored thereon computer software comprising a set of instructions that, when executed by the at least one processor, causes the apparatus to: receive a first identifier associated with at least one service; access a portal associated with the first identifier that is associated with the at least one service; receive, via the portal, a second identifier associated with a user who is requesting, from a service provider, service via one or more of at least one CPE or a user device; verify, via the portal, the second identifier associated with the user; and in response to the user providing the second identifier via the portal and the portal verifying the provided second identifier, send, via the portal, one or more updates to the at least one CPE, based at least in part on one or more of the first identifier associated with the at least one service and the second identifier associated with the user.

In yet another aspect, a system might comprise a computing system. The computing system might comprise at least one processor and a non-transitory computer readable medium communicatively coupled to the at least one processor. The non-transitory computer readable medium might have stored thereon computer software comprising a set of instructions that, when executed by the at least one processor, causes the computing system to: receive a first identifier associated with at least one service; access a portal associated with the first identifier that is associated with the at least one service; receive, via the portal, a second identifier associated with a user who is requesting, from a service provider, service via one or more of at least one CPE or a user device; verify, via the portal, the second identifier associated with the user; and in response to the user providing the second identifier via the portal and the portal verifying the provided second identifier, send, via the portal, one or more updates to the at least one CPE, based at least in part on one or more of the first identifier associated with the at least one service and the second identifier associated with the user.

Various modifications and additions can be made to the embodiments discussed without departing from the scope of the invention. For example, while the embodiments described above refer to particular features, the scope of this invention also includes embodiments having different combination of features and embodiments that do not include all of the above described features.

### Specific Exemplary Embodiments

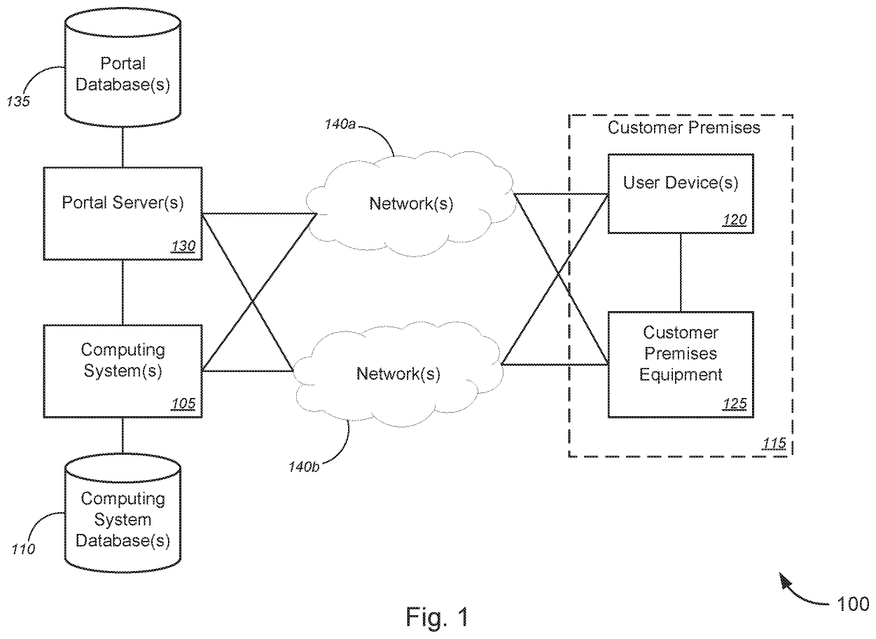

We now turn to the embodiments as illustrated by the drawings. FIGS. 1-6 illustrate some of the features of the method, system, and apparatus for implementing one or more services within a customer premises, and, more particularly, to methods, systems, and apparatuses for implementing one or more services on customer premises equipment contained within the customer premises, as referred to above. The methods, systems, and apparatuses illustrated by FIGS. 1-6 refer to examples of different embodiments that include various components and steps, which can be considered alternatives or which can be used in conjunction with one another in the various embodiments. The description of the illustrated methods, systems, and apparatuses shown in FIGS. 1-6 is provided for purposes of illustration and should not be considered to limit the scope of the different embodiments.

With reference to the figures, FIG. 1 is a schematic diagram illustrating a system 100 for implementing one or more services within a customer premises, in accordance with various embodiments.

In the non-limiting embodiment of FIG. 1, system 100 might comprise a computing system(s) 105 and corresponding database(s) 110 providing at least one of connectivity, routines, tools, communication protocols, and/or the like, to instantiate one or more services. Alternatively, computing system(s) 105 might be a local computing system(s) located within customer premises 115. System 100 might further comprise one or more user devices 120 and/or one or more customer premises equipment (“CPE”) 125. In some cases, the one or more user devices 120 and/or CPE 125 might be local to and/or might be integrated with the computing system(s) 105 and corresponding database(s) 110. In other cases, the one or more user devices 120 and/or CPE 125 might be remote from the computing system(s) 105 and corresponding database(s) 110. System 100 might additionally include one or more portal servers 130 and corresponding databases 135.

In some embodiments, the computing system(s) 105 might each include, without limitation, one of a processor of a user device, a server computer, a server computer over a network, a cloud-based computing system over a network, or a distributed computing system, and/or the like.

In some cases, the user device(s) 115 might each include, without limitation, at least one of a desktop computer, a laptop computer, a tablet computer, a smart phone, a cellphone, a personal digital assistant, a remote-control device, or a portable gaming device, and/or the like.

CPE 125 might each include, without limitation, one of a modem, a router, a firewall, an optical network terminal, a set-top box, a wireless access point, a gateway, a media player, a gaming console, a camera, a sensor, a thermostat, a desktop computer, or a laptop computer, and/or the like. The modem might include, but is not limited to, at least one of a digital subscriber line modem, a G.fast modem, or a cable modem, and/or the like. The set-top box might include an Internet protocol television set-top box, or an over-the-top set-top box, and/or the like. The gateway might include, without limitation, at least one of a residential gateway, a business gateway, a pay-per-view gateway, or a security gateway, and/or the like.

In various embodiments, CPE 125 might be a universal CPE which may be configured to adapt to perform functionalities associated with a dedicated CPE. In other words, the universal CPE may be unassociated with any dedicated device (e.g., gateway, firewall, STB, etc.) until one or more functionalities associated with a dedicated device are downloaded onto the universal CPE. Once the one or more functionalities are downloaded onto the universal CPE, the universal CPE may adapt to perform as one of a modem, a router, an optical network terminal, a STB, a gateway, a media player, a gaming console, a camera, a sensor, a thermostat, a desktop computer, or a laptop computer, and/or the like. In some cases, the universal CPE may function as two or more of a modem, a router, a firewall, an optical network terminal, a set-top box, a wireless access point, a gateway, a media player, a gaming console, a camera, a sensor, a thermostat, a desktop computer, or a laptop computer, and/or the like.

The computing system(s) 105 might communicatively couple to each of the one or more user devices 120 and/or CPE 125 via a wireless connection and/or a wired connection. Each of the one or more user devices 120 might communicatively couple to the CPE 125, either via wireless connection and/or via wired connection. In some cases, the CPE 125 might be paired, synced, or synchronized with the one or more user devices 120.

In some cases, the computing system(s) 105, the one or more user devices 120, and/or CPE 125 may be disposed within a customer premises 115, which might be one of a single family house, a multi-dwelling unit (“MDU”) within a multi-dwelling complex (including, but not limited to, an apartment building, an apartment complex, a condominium complex, a townhouse complex, a mixed-use building, etc.), a motel, an inn, a hotel, an office building or complex, a commercial building or complex, a store, a mall, or an industrial building or complex, and/or the like.

System 100 might further include a portal server(s) 130 and a corresponding portal database(s) 135 providing at least one of connectivity, routines, tools, communication protocols, and/or the like, to instantiate one or more services on user device(s) 120 and/or CPE 125. The portal server(s) 130 might be local to and/or integrated with computing system(s) 105 and/or remote from computing system(s) 105. The portal database(s) 135 might be local to and/or integrated with computing system database(s) 110 and/or remote from computing system database(s) 110.

The portal server(s) 135 might host a portal which may include, without limitation, at least one of a software application or a website. The portal might include service offerings that may be instantiated at a customer premises 115 on one or more user devices 120 and/or CPE 125.

The computing system(s) 105 might communicatively couple with each of the user devices 120, CPE 125, and/or portal server(s) 130 via network(s) 140a and 140b (collectively, “network(s) 140,” or the like). Additionally and/or alternatively, user device(s) 120 and/or CPE 125 might communicatively couple with portal server(s) 130 via network(s) 140.

In operation, computing system(s) 105 might receive a first identifier associated with at least one service. Alternatively, the first identifier might be associated with CPE 125. The first identifier associated with CPE 125 might identify a type of CPE 125 which the computing system(s) 105 might use to determine one or more services that are compatible with CPE 125. The computing system(s) 105 might receive the first identifier from at least one of computing system(s) 105, user device(s) 120, and/or CPE 125, and/or the like.

The computing system(s) 105 might receive the first identifier from the computing system(s) 105, user device(s) 120, and/or CPE 125 when the computing system(s) 105, user device(s) 120, and/or CPE 125 scans the first identifier, takes a picture of the first identifier, or receives the first identifier via user input, and/or the like. Additionally and/or alternatively, the computing system(s) 105 might receive the first identifier when the CPE 125 first powers up or connects to network(s) 140.

The first identifier might include, without limitation, one or more of a unique identifier, a QR code, a barcode, a serial number, a number sequence, a letter sequence, or a number and letter sequence, and/or the like. The at least one service might include, without limitation, at least one of one or more services associated with a dedicated CPE, one or more video services, one or more wireless services, one or more services associated with one or more virtual machines, one or more over the top services, updates associated with the one or more services associated with the dedicated CPE, updates associated with the one or more video services, updates associated with the one or more wireless services, updates associated with the one or more services associated with the one or more virtual machines, or updates associated with the one or more over the top services, and/or the like.

The first identifier might cause the computing system(s) 105 to open a portal associated with the first identifier via the portal server(s) 130. In other words, location information associated with a portal may be included within the identifier associated with the at least one service and/or the CPE 125. The portal might be at least one of a software application or a website. In some cases, the portal might be opened and displayed on at least one of computing system(s) 105, user device(s) 120, and/or CPE 125, and/or the like.

The computing system(s) 105 might further receive, via the portal, a second identifier associated with a user who is requesting, from a service provider, service via one or more of at least one CPE or a user device(s). The second identifier might include, without limitation, one or more of a unique identifier associated with the user, a QR code associated with the user, a serial number associated with the user, a number sequence associated with the user, a letter sequence associated with the user, a number and letter sequence associated with the user, a username associated with the user, a password associated with the user, or an Internet protocol address associated with the user, and/or the like.

The second identifier might be received by computing system(s) 105 from the computing system(s) 105, user device(s) 120, and/or CPE 125 when the computing system(s) 105, user device(s) 120, and/or CPE 125 scans the second identifier, takes a picture of the second identifier, or receives the second identifier via user input, and/or the like

The computing system(s) 105 may then verify the second identifier associated with the user. In other words, the computing system(s) 105 may confirm that the second identifier is associated with a user or customer of the service provider. The computing system(s) 105 may further verify that a user is authorized to receive one or more services associated with the first identifier.

In response to the user providing the second identifier via the portal and the portal verifying the provided second identifier, the computing system(s) 105, user device(s) 120, and/or CPE 125 might then display one or more services that are available within the portal. The portal might display one or more available services associated with the first identifier associated with the at least one service. Additionally and/or alternatively, the portal might display one or more services that are compatible with the first identifier associated with the CPE 125.

In some cases, the computing system(s) 105 might additionally determine a location associated with the user device(s) 120 and/or CPE 125 and/or a customer premises 115 associated with the user device(s) 120 and/or CPE 125. The portal might then determine and display one or more services that are available at the location associated with the user device(s) 120 and/or CPE 125 and/or at a customer premises 115 associated with the user device(s) 120 and/or CPE 125.

In some embodiments, the computing system(s) 105 might also determine one or more available CPE 125 located at the location and/or at the customer premises 115 associated with the user device(s) 120. The portal might then determine and display one or more services that are compatible with CPE 125 located at the same location and/or customer premises 115 as user device(s) 120.

In various instances, the computing system(s) 105 might determine whether the at least one service associated with the first identifier is available at the location and/or customer premises 115 associated with the user device(s) 120 and/or CPE 125. If the computing system(s) 105 determines that the service is not available, the computing system(s) 105 might cause the portal to display a list of one or more CPE 125 that are required to implement the service at the customer premises 115. A user may then order the required CPE via the portal. If the CPE required for a service is not available or the service is not available in a particular location and/or customer premises, computing system(s) 105, via the portal, might display alternative services that are available at a particular location and/or customer premises 115.

A user may then interact with the portal to select one or more available services associated with the at least one first identifier associated with the service, the at least one first identifier associated with CPE 125, the location and/or customer premises 115 associated with the user device(s) 120 and/or CPE 125, and/or the CPE 125 located at the same location and/or customer premises 115 as user device(s) 120.

In some cases, in response to the user providing the second identifier via the portal and the portal verifying the provided second identifier, the computing system(s) 105 may then automatically (without user input) send, via the portal, one or more updates to the at least one user device 120 and/or CPE 125, based at least in part on one or more of the first identifier associated with the at least one service and the second identifier associated with the user. Alternatively, after receiving a user selection of one or more available services, the computing system(s) 105 may then send, via the portal, one or more updates to the at least one user device 120 and/or CPE 125, based at least in part on one or more of the first identifier associated with the at least one service and the second identifier associated with the user.

The one or more updates might include, without limitation, at least one of one or more functionalities associated with a dedicated CPE, one or more functionalities associated with one or more video services, one or more functionalities associated with one or more wireless services, one or more functionalities associated with one or more virtual machines, one or more functionalities associated with over the top services, updates associated with the one or more functionalities associated with the dedicated CPE, updates associated with the one or more functionalities associated with the one or more video services, updates associated with the one or more functionalities associated with the one or more wireless services, updates associated with the one or more functionalities associated with the one or more virtual machines, or updates associated with the one or more functionalities associated with the over the top services, and/or the like.

Based on a determination of the location associated with the at least one CPE, the computing system might determine one or more communication channels to autonomously send the one or more updates. For example, a service provider might prioritize its network(s) 140a over a third party's network(s) 140b.

Based on a determination of the location associated with the at least one CPE 125, the computing system(s) 105 might determine one or more times to autonomously send the one or more updates. In weak or slow service areas, one or more updates or services may be pushed to the at least one CPE during non-peak network traffic times to avoid overloading one or more communications paths and/or network(s) 140.

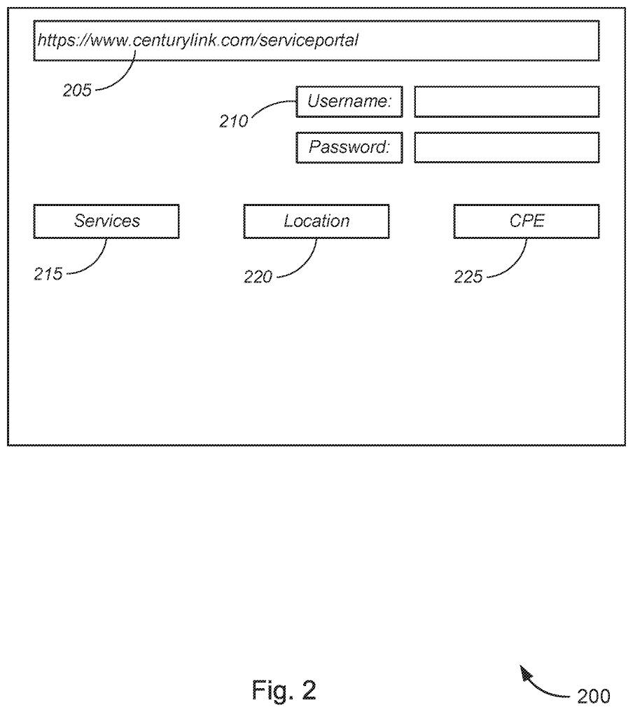

These and other aspects of the various embodiments are described in detail below with respect to FIGS. 2-4.

FIG. 2 is a schematic diagram illustrating an example of a portal 200 for implementing one or more services at a customer premises.

Portal 200 might be at least one of a software application (not shown) or website (shown in FIG. 2) 205, and/or the like. Portal 200 might be hosted on a computing system (e.g., computing system(s) 105 of FIG. 1, and/or the like) or a server computer (e.g., portal server(s) 130 of FIG. 1, and/or the like).

A user may access portal 200 via an identifier 210 associated with the user. The identifier associated with the user might be at least one of a QR code associated with the user, a serial number associated with the user, a number sequence associated with the user, a letter sequence associated with the user, a number and letter sequence associated with the user, a username associated with the user, a password associated with the user, or an Internet protocol address associated with the user, and/or the like. The portal might be accessed via a computing system, a user device (e.g., user device(s) 120 of FIG. 1), and/or CPE (e.g., CPE 125 of FIG. 1), or the like.

Alternatively, portal 200 might be automatically accessed via a computing system, a user device, and/or CPE. The computing system, user device, and/or CPE might utilize an identifier associated with one or more services and/or an identifier associated with one or more CPE to access portal 200. The computing system, user device, and/or CPE might scan, take a picture of, and/or receive user input of the identifier associated with one or more services and/or an identifier associated with one or more CPE. In a non-limiting example, a user may receive a pamphlet from a service provider offering a new and/or updated service with a QR code associated with the new and/or updated service. The user may scan the QR code with a user device and the user device may automatically access portal 200. In another non-limiting example, a user may receive a CPE with a QR code associated with the CPE. The user may scan the QR code with a user device and the user device may automatically access portal 200.

In some cases, once the identifier associated with the at least one service and/or CPE is used to open the portal and the identifier associated with the user is used to access the portal, the computing system, via the portal, may automatically (without further input from the user) configure one or more CPE and/or user devices with the one or more services associated with the identifier associated with the at least one service and/or CPE.

Alternatively, once a user accesses portal 200, with the identifier associated with the user, the user may view one or more available services 215. The portal 200 may display one or more available services 215 associated with one or more of the identifier associated with the at least one service and/or the identifier associated with one or more CPE. Additionally and/or alternatively, the portal 200, via a computing system, may determine a location and/or one or more CPE associated with the user device accessing the portal 200 and may display one or more available services 215 available in the location associated with the user device and/or one or more available services available with the one or more CPE associated with the user device.

In some cases, a user may then select one or more available updates to send to a customer premises, to a user device, and/or to a CPE. In some embodiments, once a user accesses portal 200, the user may select one or more locations and/or customer premises 220 to send the one or more available services 215. When a CPE is powered up and/or connected to a network in the selected locations and/or customer premises 220, the portal 200, via the computing system, may automatically send the one or more services to the CPE 225 in the selected locations.

In some cases, a user may use the portal 200 to pre-configure CPE in selected locations and/or customer premises 220. When a CPE is powered up and/or connected to a network in the selected locations, the portal 200, via the computing system, may automatically send the one or more services to the CPE in the selected locations. The portal may use the identifier associated with the CPE to ensure that the correct CPE is installed at the customer premises.

In various cases, the portal 200 might further display one or more CPE 225 and/or a list of one or more CPE 225 that are needed to implement the selected services at the customer premises and/or the service associated with the identifier.

In some instances, a user may pre-configure multiple CPE via portal 200. The user may further associate the CPE with different locations. Once the CPE is installed at a corresponding location (which may be verified via the identifier associated with the CPE), the portal 200, via a computing system, may push one or more updates to the CPE. The portal may use the identifier associated with the CPE to ensure that the correct CPE is installed at the customer premises.

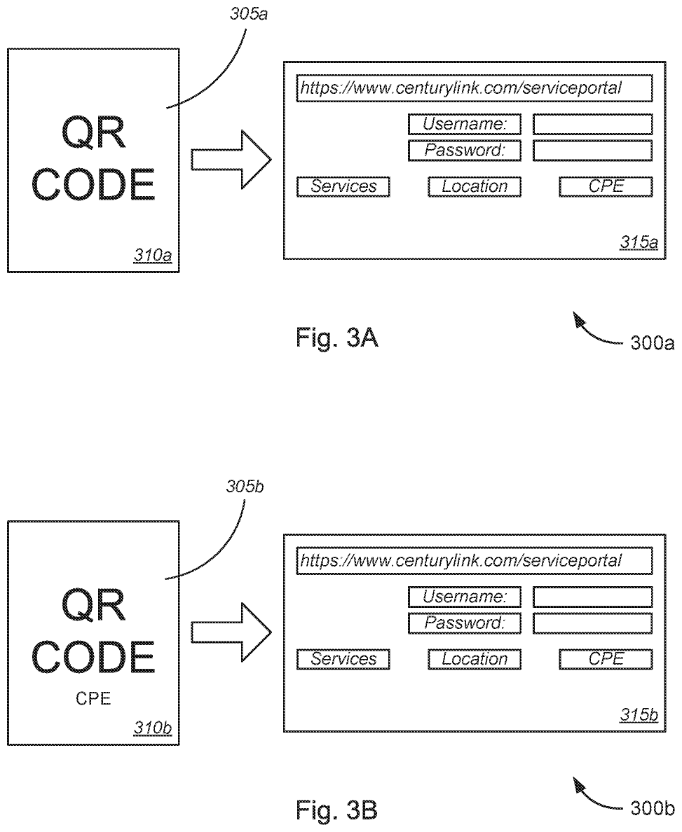

FIGS. 3A and 3B (collectively, “FIG. 3”) are schematic diagrams illustrating examples of using one or more identifiers to access a portal for implementing one or more services within a customer premises, in accordance with various embodiments.

In system 300a of FIG. 3A, a first identifier 305a associated with a service may be included on an object 310a, which might include, without limitation, at least one of an advertising pamphlet, promotional material, a CPE, a billboard, a poster, and/or the like. A user may, via a computing system (e.g., computing system(s) 105 of FIG. 1), a user device (e.g., user device(s) 120 of FIG. 1), and/or a CPE (e.g., CPE 125 of FIG. 1), and/or the like, scan the first identifier 305a, take a picture of the first identifier 305a, or enter the first identifier 305a via user input, and/or the like. By scanning, taking a picture of, and/or entering user input of the first identifier 305a, the user, via the computing system, user device, and/or CPE, may be directed to a portal 315a. A user may enter a second identifier associated with the user to access the portal 315a. The portal 315a may then function in a similar manner as the portals described above with respect to FIGS. 1 and 2. In a non-limiting example, the portal 315a, via a computing system, may automatically configure one or more user devices and/or CPE with the at least one service associated with the identifier 305a. Alternatively, the portal 315a, via a computing system, may display one or more services associated with the first identifier 305a and the user may select one or more services to implement on a user device and/or CPE.

In system 300b of FIG. 3B, a first identifier 305b associated with CPE 310b may be included on CPE 310b, and/or the like. A user may, via a computing system (e.g., computing system(s) 105 of FIG. 1), a user device (e.g., user device(s) 120 of FIG. 1), and/or a CPE (e.g., CPE 125 of FIG. 1), and/or the like, scan the first identifier 305b, take a picture of the first identifier 305b, or enter the first identifier 305b via user input, and/or the like. By scanning, taking a picture of, and/or entering user input of the first identifier 305a, the user, via the computing system, user device, and/or CPE, may be directed to a portal 315b. A user may enter a second identifier associated with the user to access the portal 315b. The portal 310 may then function in a similar manner as the portals described above with respect to FIGS. 1 and 2. In a non-limiting example, the portal 315b, via a computing system, may verify that the CPE 310b has been installed at the correct location and/or customer premises. The portal 315b, via a computing system, may associate CPE 310b with the location and/or customer premises. The portal 315b, via a computing system, may automatically configure the CPE with the at least one service. Alternatively, the portal 315b, via a computing system, may display one or more services that are compatible with the CPE 310b associated with the first identifier 305, and the user may select one or more services to implement on the CPE 310b.

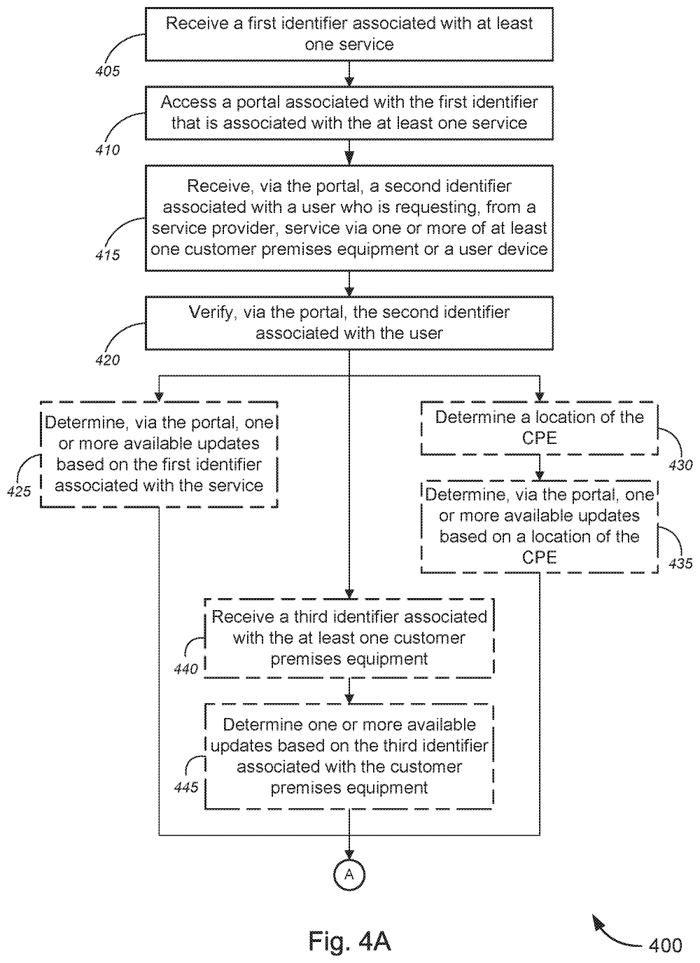

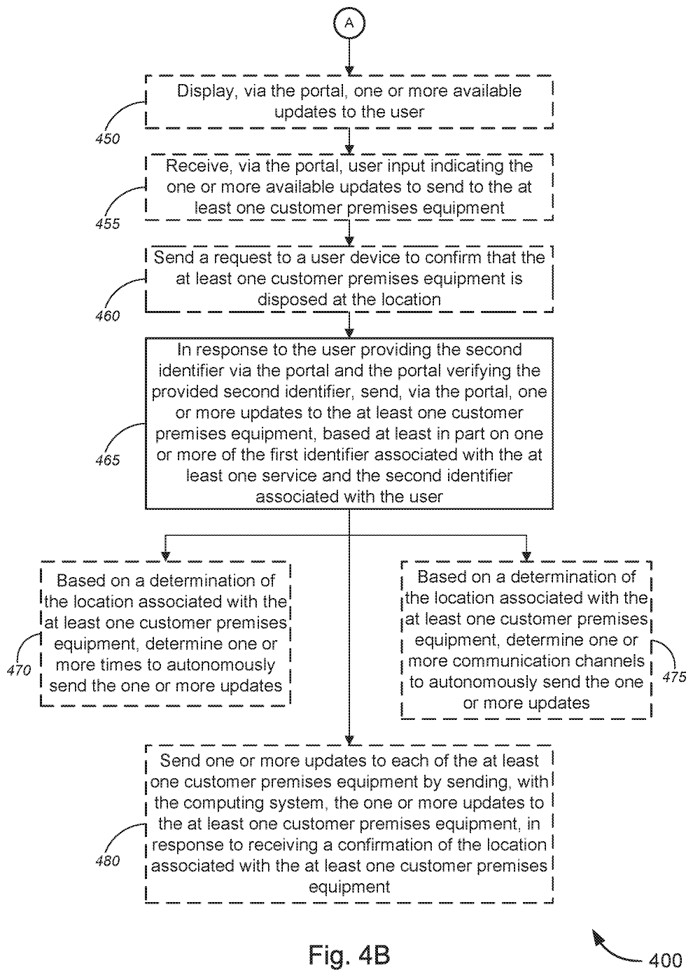

FIGS. 4A and 4B (collectively, “FIG. 4”) are flow diagrams illustrating a method 400 for implementing one or more services within a customer premises, in accordance with various embodiments.

While the techniques and procedures are depicted and/or described in a certain order for purposes of illustration, it should be appreciated that certain procedures may be reordered and/or omitted within the scope of various embodiments. Moreover, while the method 400 illustrated by FIG. 4 can be implemented by or with (and, in some cases, are described below with respect to) the systems, examples, or embodiments 100, 200, 300a, and 300b of FIGS. 1, 2, 3A, and 3B, respectively (or components thereof), such methods may also be implemented using any suitable hardware (or software) implementation. Similarly, while each of the systems, examples, or embodiments 100, 200, 300a, and 300b of FIGS. 1, 2, 3A, and 3B, respectively (or components thereof), can operate according to the method 400 illustrated by FIG. 4 (e.g., by executing instructions embodied on a computer readable medium), the systems, examples, or embodiments 100, 200, 300a, and 300b of FIGS. 1, 2, 3A, and 3B can each also operate according to other modes of operation and/or perform other suitable procedures.

In the non-limiting embodiment of FIG. 4A, method 400, at block 405, might comprise receiving, with a computing system, a first identifier associated with at least one service. In a non-limiting example, the computing system may receive the first identifier by scanning the first identifier, taking a picture of the first identifier, or receiving the first identifier via user input, and/or the like. Additionally and/or alternatively, the computing system may receive the first identifier from a user device. The user device may scan the first identifier, take a picture of the first identifier, or receive the first identifier via user input. The computing system may be local to the user device and/or remote from the user device. The user device might include, without limitation, at least one of a desktop computer associated with the user, a laptop computer associated with the user, a tablet computer associated with the user, a smart phone associated with the user, a cellphone associated with the user, a personal digital assistant associated with the user, a remote-control device associated with the user, or a portable gaming device associated with the user, and/or the like.

In some embodiments, the computing system might include, without limitation, a server computer over a network, a cloud-based computing system over a network, or a distributed computing system, and/or the like. In some instances, the first identifier might include, but is not limited to, at least one of a unique identifier, a QR code, a bar code, a serial number, a number sequence, a letter sequence, or a number and letter sequence, and/or the like. In various embodiments, the first identifier might be associated with a CPE and function in a similar way as the first identifier associated with the at least one service.

In some cases, the at least one service might include, without limitation, at least one of one or more services associated with a dedicated CPE, one or more video services, one or more wireless services, one or more services associated with one or more virtual machines, one or more over the top services, updates associated with the one or more services associated with the dedicated CPE, updates associated with the one or more video services, updates associated with the one or more wireless services, updates associated with the one or more services associated with the one or more virtual machines, or updates associated with the one or more over the top services, and/or the like.

At block 410, method 400 might include accessing, with the computing system, a portal associated with the first identifier that is associated with the at least one service. The first identifier may provide location information associated with the portal. For example, the first identifier may be associated with the portal. The portal, might include, without limitation, at least one of a software application or a website, and/or the like.

A user may interact with the portal prior to receiving the first identifier to configure services associated with different CPE. For example, a user may log in to the portal to order a CPE, configure one or more services for the ordered CPE, configure one or more services associated different locations, and/or the like.

In various cases, the computing system may then display the portal to a user on a user device. A user might use a user device to access the portal.

In some cases, the method 400 might include, at block 415, receiving, with the computing system and via the portal, a second identifier associated with a user who is requesting, from a service provider, service via one or more of at least one CPE or a user device. The second identifier might include without limitation, one or more of a unique identifier associated with the user, a QR code associated with the user, a serial number associated with the user, a number sequence associated with the user, a letter sequence associated with the user, a number and letter sequence associated with the user, a username associated with the user, a password associated with the user, or an Internet protocol address associated with the user, and/or the like. The user may enter the second identifier via the display on the user device. Alternatively, the computing system may automatically determine the second identifier associated with the user. For example, the computing system may detect an Internet protocol address associated with the user device and determine that the Internet protocol address is associated with an authorized user.

At block 420, the method 400 might continue by verifying, with the computing system and via the portal, the second identifier associated with the user. In other words, the computing system might determine whether a user is authorized to receive one or more services associated with the first identifier or determine whether a user is a customer of the service provider.

In various embodiments, optional blocks 425-445 represent one or more ways for determining one or more available services and/or one or more available service updates. The one or more updates might include, without limitation, at least one of one or more functionalities associated with a dedicated CPE, one or more functionalities associated with one or more video services, one or more functionalities associated with one or more wireless services, one or more functionalities associated with one or more virtual machines, one or more functionalities associated with over the top services, updates associated with the one or more functionalities associated with the dedicated CPE, updates associated with the one or more functionalities associated with the one or more video services, updates associated with the one or more functionalities associated with the one or more wireless services, updates associated with the one or more functionalities associated with the one or more virtual machines, or updates associated with the one or more functionalities associated with the over the top services, and/or the like.

At optional block 425, the method 400 might include determining, with the computing system and via the portal, one or more available updates based on the first identifier associated with the service. In other words, the first identifier may indicate one or more available services and/or one or more available service updates.

At optional block 430, the method 400 might comprise determining, with the computing system, a location associated with the at least one CPE and, at optional block 435, determining, with the computing system and via the portal, one or more available updates based on the location associated with the at least one CPE.

In some cases, the method 400 might determine a location associated with a user device and determine one or more available CPE that are located at the location associated with the user device. The computing system may then determine available functionalities of the CPE. Based on the determination of the CPE located at the location of the user device and the CPE's corresponding functionalities, the computing system, via the portal, might determine one or more available services and/or service updates based on the available CPE.

At optional block 440, the method might include receiving, with the computing system, a third identifier associated with the at least one CPE and, at optional block 445, determining, with the computing system, one or more available updates based on the third identifier associated with the CPE. The third identifier might include, without limitation, at least one of a unique identifier, a QR code, a bar code, a serial number, a number sequence, a letter sequence, or a number and letter sequence, and/or the like. The third identifier might indicate a type of CPE and indicate one or more services and/or one or more service updates that are compatible with the CPE. Additionally and/or alternatively, the third identifier of the CPE might function in a similar manner as the first identifier associated with the service. The CPE might be equipped with a third identifier that a user may use to access the portal.

Once the computing system determines one or more available updates, method 400 (following circular marker denoted, “A,” to FIG. 4B) might proceed, at optional block 450, with displaying, with the computing system and via the portal, one or more available updates to the user. The updates may be displayed on the computing system and/or on a user device.

Next, at optional block 455, method 400 might include, without limitation, receiving, with the computing system and via the portal, user input indicating the one or more available updates to send to the at least one CPE.

Before the one or more updates are sent to the at least one CPE, the method 400, at optional block 460, might comprise sending, with the computing system, a request to a user device to confirm that the at least one CPE is disposed at the location. The request may be sent to the user device via at least one of an email, a text message, or a voice call, and/or the like.

In response to the user providing the second identifier via the portal and the portal verifying the provided second identifier, the method 400, at block 465, might further comprise sending, with the computing system and via the portal, one or more updates to the at least one CPE, based at least in part on one or more of the first identifier associated with the at least one service and the second identifier associated with the user.

Optional blocks 470-480 of the method 400 represent different factors that may affect sending, with the computing system and via the portal, one or more updates to the at least one CPE. At optional block 470, method 400 might include, based on a determination of the location associated with the at least one CPE, determining, with the computing system, one or more times to autonomously send the one or more updates. In weak or slow service areas, one or more updates or services may be pushed to the at least one CPE during non-peak network traffic times to avoid overloading one or more communications paths.

At optional block 475, method 400 might include, based on a determination of the location associated with the at least one CPE, determining, with the computing system, one or more communication channels to autonomously send the one or more updates. For example, a service provider might prioritize its own communication paths over a third party's communication path.

At optional block 480, method 400 might comprise sending, with the computing system and via the portal, one or more updates to each of the at least one CPE by sending, with the computing system, the one or more updates to the at least one CPE, in response to receiving a confirmation of the location associated with the at least one CPE.

### Exemplary System and Hardware Implementation

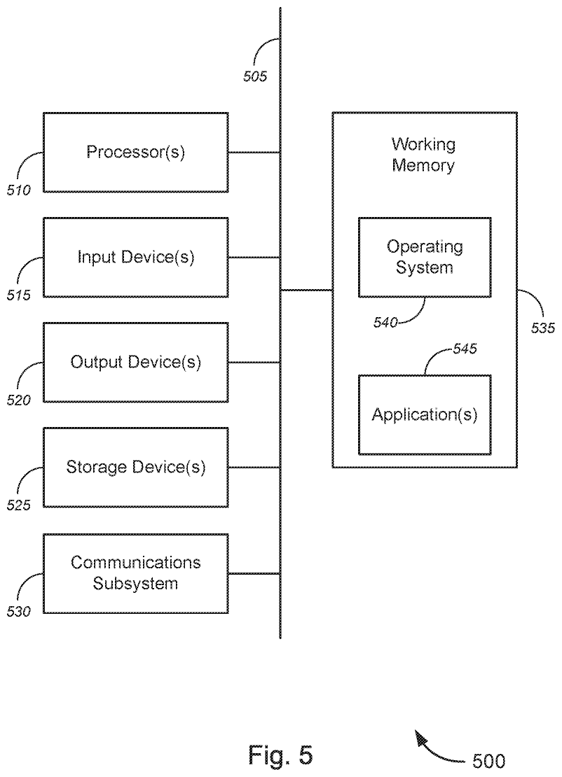

FIG. 5 is a block diagram illustrating an exemplary computer or system hardware architecture, in accordance with various embodiments. FIG. 5 provides a schematic illustration of one embodiment of a computer system 500 of the service provider system hardware that can perform the methods provided by various other embodiments, as described herein, and/or can perform the functions of computer or hardware system (i.e., computing system(s) 105, user device(s) 120, CPE 125, 310a, and 310b, and portal server(s) 130, etc.), as described above. It should be noted that FIG. 5 is meant only to provide a generalized illustration of various components, of which one or more (or none) of each may be utilized as appropriate. FIG. 5, therefore, broadly illustrates how individual system elements may be implemented in a relatively separated or relatively more integrated manner.

The computer or hardware system 500—which might represent an embodiment of the computer or hardware system (i.e., computing system(s) 105, user device(s) 120, CPE 125, 310a, and 310b, and portal server(s) 130, etc.), described above with respect to FIGS. 1-4—is shown comprising hardware elements that can be electrically coupled via a bus 505 (or may otherwise be in communication, as appropriate). The hardware elements may include one or more processors 510, including, without limitation, one or more general-purpose processors and/or one or more special-purpose processors (such as microprocessors, digital signal processing chips, graphics acceleration processors, and/or the like); one or more input devices 515, which can include, without limitation, a mouse, a keyboard, and/or the like; and one or more output devices 520, which can include, without limitation, a display device, a printer, and/or the like.

The computer or hardware system 500 may further include (and/or be in communication with) one or more storage devices 525, which can comprise, without limitation, local and/or network accessible storage, and/or can include, without limitation, a disk drive, a drive array, an optical storage device, solid-state storage device such as a random access memory (“RAM”) and/or a read-only memory (“ROM”), which can be programmable, flash-updateable, and/or the like. Such storage devices may be configured to implement any appropriate data stores, including, without limitation, various file systems, database structures, and/or the like.

The computer or hardware system 500 might also include a communications subsystem 530, which can include, without limitation, a modem, a network card (wireless or wired), an infra-red communication device, a wireless communication device and/or chipset (such as a Bluetooth™ device, an 802.11 device, a WiFi device, a WiMax device, a WWAN device, cellular communication facilities, etc.), and/or the like. The communications subsystem 530 may permit data to be exchanged with a network (such as the network described below, to name one example), with other computer or hardware systems, and/or with any other devices described herein. In many embodiments, the computer or hardware system 500 will further comprise a working memory 535, which can include a RAM or ROM device, as described above.

The computer or hardware system 500 also may comprise software elements, shown as being currently located within the working memory 535, including an operating system 540, device drivers, executable libraries, and/or other code, such as one or more application programs 545, which may comprise computer programs provided by various embodiments (including, without limitation, hypervisors, VMs, and the like), and/or may be designed to implement methods, and/or configure systems, provided by other embodiments, as described herein. Merely by way of example, one or more procedures described with respect to the method(s) discussed above might be implemented as code and/or instructions executable by a computer (and/or a processor within a computer); in an aspect, then, such code and/or instructions can be used to configure and/or adapt a general purpose computer (or other device) to perform one or more operations in accordance with the described methods.

A set of these instructions and/or code might be encoded and/or stored on a non-transitory computer readable storage medium, such as the storage device(s) 525 described above. In some cases, the storage medium might be incorporated within a computer system, such as the system 500. In other embodiments, the storage medium might be separate from a computer system (i.e., a removable medium, such as a compact disc, etc.), and/or provided in an installation package, such that the storage medium can be used to program, configure, and/or adapt a general purpose computer with the instructions/code stored thereon. These instructions might take the form of executable code, which is executable by the computer or hardware system 500 and/or might take the form of source and/or installable code, which, upon compilation and/or installation on the computer or hardware system 500 (e.g., using any of a variety of generally available compilers, installation programs, compression/decompression utilities, etc.) then takes the form of executable code.

It will be apparent to those skilled in the art that substantial variations may be made in accordance with specific requirements. For example, customized hardware (such as programmable logic controllers, field-programmable gate arrays, application-specific integrated circuits, and/or the like) might also be used, and/or particular elements might be implemented in hardware, software (including portable software, such as applets, etc.), or both. Further, connection to other computing devices such as network input/output devices may be employed.

As mentioned above, in one aspect, some embodiments may employ a computer or hardware system (such as the computer or hardware system 500) to perform methods in accordance with various embodiments of the invention. According to a set of embodiments, some or all of the procedures of such methods are performed by the computer or hardware system 500 in response to processor 510 executing one or more sequences of one or more instructions (which might be incorporated into the operating system 540 and/or other code, such as an application program 545) contained in the working memory 535. Such instructions may be read into the working memory 535 from another computer readable medium, such as one or more of the storage device(s) 525. Merely by way of example, execution of the sequences of instructions contained in the working memory 535 might cause the processor(s) 510 to perform one or more procedures of the methods described herein.

The terms “machine readable medium” and “computer readable medium,” as used herein, refer to any medium that participates in providing data that causes a machine to operate in a specific fashion. In an embodiment implemented using the computer or hardware system 500, various computer readable media might be involved in providing instructions/code to processor(s) 510 for execution and/or might be used to store and/or carry such instructions/code (e.g., as signals). In many implementations, a computer readable medium is a non-transitory, physical, and/or tangible storage medium. In some embodiments, a computer readable medium may take many forms, including, but not limited to, non-volatile media, volatile media, or the like. Non-volatile media includes, for example, optical and/or magnetic disks, such as the storage device(s) 525. Volatile media includes, without limitation, dynamic memory, such as the working memory 535. In some alternative embodiments, a computer readable medium may take the form of transmission media, which includes, without limitation, coaxial cables, copper wire, and fiber optics, including the wires that comprise the bus 505, as well as the various components of the communication subsystem 530 (and/or the media by which the communications subsystem 530 provides communication with other devices). In an alternative set of embodiments, transmission media can also take the form of waves (including without limitation radio, acoustic, and/or light waves, such as those generated during radio-wave and infra-red data communications).

Common forms of physical and/or tangible computer readable media include, for example, a floppy disk, a flexible disk, a hard disk, magnetic tape, or any other magnetic medium, a CD-ROM, any other optical medium, punch cards, paper tape, any other physical medium with patterns of holes, a RAM, a PROM, and EPROM, a FLASH-EPROM, any other memory chip or cartridge, a carrier wave as described hereinafter, or any other medium from which a computer can read instructions and/or code.

Various forms of computer readable media may be involved in carrying one or more sequences of one or more instructions to the processor(s) 510 for execution. Merely by way of example, the instructions may initially be carried on a magnetic disk and/or optical disc of a remote computer. A remote computer might load the instructions into its dynamic memory and send the instructions as signals over a transmission medium to be received and/or executed by the computer or hardware system 500. These signals, which might be in the form of electromagnetic signals, acoustic signals, optical signals, and/or the like, are all examples of carrier waves on which instructions can be encoded, in accordance with various embodiments of the invention.

The communications subsystem 530 (and/or components thereof) generally will receive the signals, and the bus 505 then might carry the signals (and/or the data, instructions, etc. carried by the signals) to the working memory 535, from which the processor(s) 505 retrieves and executes the instructions. The instructions received by the working memory 535 may optionally be stored on a storage device 525 either before or after execution by the processor(s) 510.

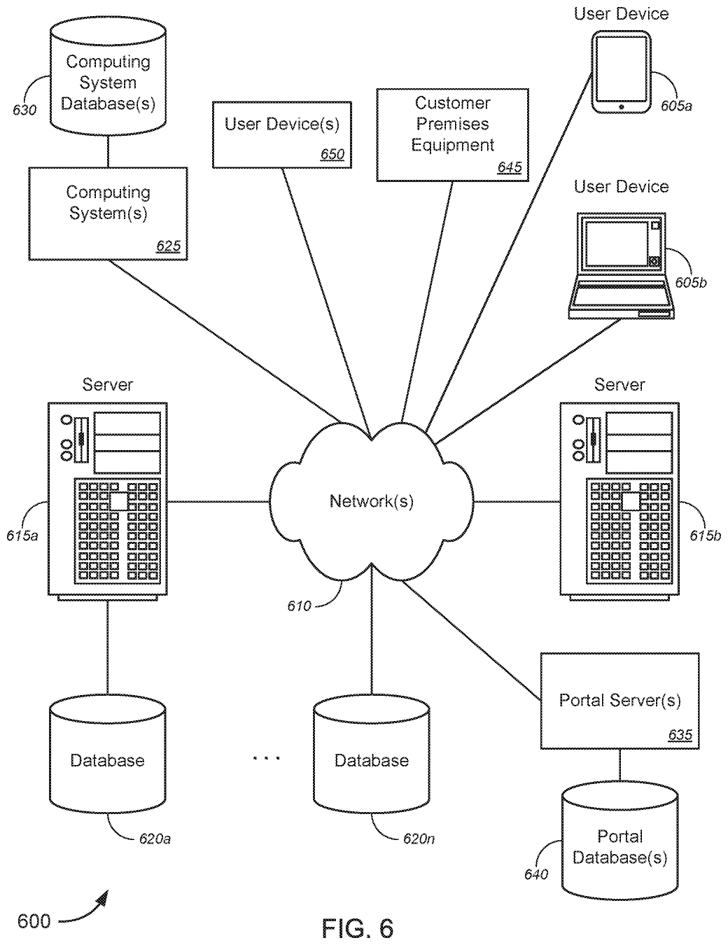

As noted above, a set of embodiments comprises methods and systems for implementing one or more services within a customer premises, and, more particularly, to methods, systems, and apparatuses for implementing one or more services on CPE contained within the customer premises. FIG. 6 illustrates a schematic diagram of a system 600 that can be used in accordance with one set of embodiments. The system 600 can include one or more user computers, user devices, or customer devices 605. A user computer, user device, or customer device 605 can be a general purpose personal computer (including, merely by way of example, desktop computers, tablet computers, laptop computers, handheld computers, and the like, running any appropriate operating system, several of which are available from vendors such as Apple, Microsoft Corp., and the like), cloud computing devices, a server(s), and/or a workstation computer(s) running any of a variety of commercially-available UNIX™ or UNIX-like operating systems. A user computer, user device, or customer device 605 can also have any of a variety of applications, including one or more applications configured to perform methods provided by various embodiments (as described above, for example), as well as one or more office applications, database client and/or server applications, and/or web browser applications. Alternatively, a user computer, user device, or customer device 605 can be any other electronic device, such as a thin-client computer, Internet-enabled mobile telephone, and/or personal digital assistant, capable of communicating via a network (e.g., the network(s) 610 described below) and/or of displaying and navigating web pages or other types of electronic documents. Although the exemplary system 600 is shown with two user computers, user devices, or customer devices 605, any number of user computers, user devices, or customer devices can be supported.

Certain embodiments operate in a networked environment, which can include a network(s) 610. The network(s) 610 can be any type of network familiar to those skilled in the art that can support data communications using any of a variety of commercially-available (and/or free or proprietary) protocols, including, without limitation, TCP/IP, SNA™, IPX™, AppleTalk™, and the like. Merely by way of example, the network(s) 610 (similar to network(s) 140a or 140b of FIG. 1, or the like) can each include a local area network (“LAN”), including, without limitation, a fiber network, an Ethernet network, a Token-Ring™ network, and/or the like; a wide-area network (“WAN”); a wireless wide area network (“WWAN”); a virtual network, such as a virtual private network (“VPN”); the Internet; an intranet; an extranet; a public switched telephone network (“PSTN”); an infra-red network; a wireless network, including, without limitation, a network operating under any of the IEEE 802.11 suite of protocols, the Bluetooth™ protocol known in the art, and/or any other wireless protocol; and/or any combination of these and/or other networks. In a particular embodiment, the network might include an access network of the service provider (e.g., an Internet service provider (“ISP”)). In another embodiment, the network might include a core network of the service provider, and/or the Internet.

Embodiments can also include one or more server computers 615. Each of the server computers 615 may be configured with an operating system, including, without limitation, any of those discussed above, as well as any commercially (or freely) available server operating systems. Each of the servers 615 may also be running one or more applications, which can be configured to provide services to one or more clients 605 and/or other servers 615.

Merely by way of example, one of the servers 615 might be a data server, a web server, a cloud computing device(s), or the like, as described above. The data server might include (or be in communication with) a web server, which can be used, merely by way of example, to process requests for web pages or other electronic documents from user computers 605. The web server can also run a variety of server applications, including HTTP servers, FTP servers, CGI servers, database servers, Java servers, and the like. In some embodiments of the invention, the web server may be configured to serve web pages that can be operated within a web browser on one or more of the user computers 605 to perform methods of the invention.

The server computers 615, in some embodiments, might include one or more application servers, which can be configured with one or more applications accessible by a client running on one or more of the client computers 605 and/or other servers 615. Merely by way of example, the server(s) 615 can be one or more general purpose computers capable of executing programs or scripts in response to the user computers 605 and/or other servers 615, including, without limitation, web applications (which might, in some cases, be configured to perform methods provided by various embodiments). Merely by way of example, a web application can be implemented as one or more scripts or programs written in any suitable programming language, such as Java™, C, C#™or C++, and/or any scripting language, such as Perl, Python, or TCL, as well as combinations of any programming and/or scripting languages. The application server(s) can also include database servers, including, without limitation, those commercially available from Oracle™, Microsoft™, Sybase™, IBM™, and the like, which can process requests from clients (including, depending on the configuration, dedicated database clients, API clients, web browsers, etc.) running on a user computer, user device, or customer device 605 and/or another server 615. In some embodiments, an application server can perform one or more of the processes for implementing one or more services within a customer premises, and, more particularly, to methods, systems, and apparatuses for implementing one or more services on CPE contained within the customer premises, as described in detail above. Data provided by an application server may be formatted as one or more web pages (comprising HTML, JavaScript, etc., for example) and/or may be forwarded to a user computer 605 via a web server (as described above, for example). Similarly, a web server might receive web page requests and/or input data from a user computer 605 and/or forward the web page requests and/or input data to an application server. In some cases, a web server may be integrated with an application server.

In accordance with further embodiments, one or more servers 615 can function as a file server and/or can include one or more of the files (e.g., application code, data files, etc.) necessary to implement various disclosed methods, incorporated by an application running on a user computer 605 and/or another server 615. Alternatively, as those skilled in the art will appreciate, a file server can include all necessary files, allowing such an application to be invoked remotely by a user computer, user device, or customer device 605 and/or server 615.

It should be noted that the functions described with respect to various servers herein (e.g., application server, database server, web server, file server, etc.) can be performed by a single server and/or a plurality of specialized servers, depending on implementation-specific needs and parameters.

In certain embodiments, the system can include one or more databases 620a-620n (collectively, “databases 620”). The location of each of the databases 620 is discretionary: merely by way of example, a database 620a might reside on a storage medium local to (and/or resident in) a server 615a (and/or a user computer, user device, or customer device 605). Alternatively, a database 620n can be remote from any or all of the computers 605, 615, so long as it can be in communication (e.g., via the network 610) with one or more of these. In a particular set of embodiments, a database 620 can reside in a storage-area network (“SAN”) familiar to those skilled in the art. (Likewise, any necessary files for performing the functions attributed to the computers 605, 615 can be stored locally on the respective computer and/or remotely, as appropriate.) In one set of embodiments, the database 620 can be a relational database, such as an Oracle database, that is adapted to store, update, and retrieve data in response to SQL-formatted commands. The database might be controlled and/or maintained by a database server, as described above, for example.

According to some embodiments, system 600 might further comprise a computing system(s) 625 and corresponding database(s) 630 (similar to computing system(s) 105 and corresponding database(s) 110 of FIG. 1, or the like).

In operation, the computing system(s) 625 might receive a first identifier associated with at least one service. The computing system(s) 625 might access, with the computing system, a portal associated with the first identifier that is associated with the at least one service. The portal might be hosted on computing system(s) 625 and/or hosted on portal server(s) 635 with corresponding portal database(s) 640. The computing system(s) 625 via the portal may then receive a second identifier associated with a user who is requesting, from a service provider, service via one or more of at least one CPE 645 and/or a user device 650. Next, the computing system(s) 625, via the portal, might verify that the second identifier is associated with the user. In response to the user providing the second identifier via the portal and the portal verifying the provided second identifier, the computing system(s) 625 may send, via the portal, one or more updates to the at least one CPE 645, based at least in part on one or more of the first identifier associated with the at least one service and the second identifier associated with the user.

These and other functions of the system 600 (and its components) are described in greater detail above with respect to FIGS. 1-4.

While certain features and aspects have been described with respect to exemplary embodiments, one skilled in the art will recognize that numerous modifications are possible. For example, the methods and processes described herein may be implemented using hardware components, software components, and/or any combination thereof. Further, while various methods and processes described herein may be described with respect to particular structural and/or functional components for ease of description, methods provided by various embodiments are not limited to any particular structural and/or functional architecture but instead can be implemented on any suitable hardware, firmware and/or software configuration. Similarly, while certain functionality is ascribed to certain system components, unless the context dictates otherwise, this functionality can be distributed among various other system components in accordance with the several embodiments.

Moreover, while the procedures of the methods and processes described herein are described in a particular order for ease of description, unless the context dictates otherwise, various procedures may be reordered, added, and/or omitted in accordance with various embodiments. Moreover, the procedures described with respect to one method or process may be incorporated within other described methods or processes; likewise, system components described according to a particular structural architecture and/or with respect to one system may be organized in alternative structural architectures and/or incorporated within other described systems. Hence, while various embodiments are described with—or without—certain features for ease of description and to illustrate exemplary aspects of those embodiments, the various components and/or features described herein with respect to a particular embodiment can be substituted, added and/or subtracted from among other described embodiments, unless the context dictates otherwise. Consequently, although several exemplary embodiments are described above, it will be appreciated that the invention is intended to cover all modifications and equivalents within the scope of the following claims.

What is claimed is:

1. A method, comprising:
receiving, with a computing system, a first identifier associated with at least one service;
accessing, with the computing system, a portal associated with the first identifier that is associated with the at least one service;
receiving, with the computing system and via the portal, a second identifier associated with a user who is requesting, from a service provider, service via one or more of at least one customer premises equipment or a user device;
verifying, with the computing system and via the portal, the second identifier associated with the user; and
in response to the user providing the second identifier via the portal and the portal verifying the provided second identifier, sending, with the computing system and via the portal, one or more updates to the at least one customer premises equipment, based at least in part on one or more of the first identifier associated with the at least one service and the second identifier associated with the user.

2. The method of claim 1, wherein the at least one customer premises equipment is a universal customer premises equipment which is configured to adapt to perform functionalities associated with a dedicated customer premises equipment.

3. The method of claim 2, wherein the one or more updates cause the universal customer premises equipment to adapt to perform functionalities associated with the dedicated customer premises equipment.

4. The method of claim 3, wherein the dedicated customer premises equipment comprises at least one of a modem, a router, a firewall, an optical network terminal, a set-top box, a wireless access point, a gateway, a media player, a gaming console, a camera, a sensor, a thermostat, a desktop computer, or a laptop computer.

5. The method of claim 1, wherein the portal is at least one of a software application or a website.

6. The method of claim 1, further comprising:
receiving, with the computing system and via the portal, user input selecting the one or more updates to send to the at least one customer premises equipment.

7. The method of claim 1, further comprising:
determining, with the computing system and via the portal, one or more available updates based on the first identifier associated with the at least one service; and
displaying, with the computing system and via the portal, one or more available updates to the user.

8. The method of claim 1, further comprising:
receiving, with the computing system and via the portal, user input indicating the one or more updates to push to the at least one customer premises equipment, wherein the one or more updates are associated with a location of the at least one customer premises equipment;
receiving, with the computing system, the location of the at least one customer premises equipment; and
based on the location of the at least one customer premises equipment, sending, with the computing system and to the at least one customer premises equipment, the one or more updates associated with the location of the at least one customer premises equipment.

9. The method of claim 1, further comprising:
determining, with the computing system, a location associated with the at least one customer premises equipment; and
based on a determination of the location associated with the at least one customer premises equipment, determining, with the computing system, one or more communication channels to autonomously send the one or more updates.

10. The method of claim 1, further comprising:
determining, with the computing system, a location associated with the at least one customer premises equipment; and
based on a determination of the location associated with the at least one customer premises equipment, determining, with the computing system, one or more times to autonomously send the one or more updates.

11. The method of claim 1, wherein the first identifier comprises at least one of a unique identifier, a QR code, a bar code, a serial number, a number sequence, a letter sequence, or a number and letter sequence.

12. The method of claim 1, wherein the one or more updates comprise at least one of one or more functionalities associated with a dedicated customer premises equipment, one or more functionalities associated with one or more video services, one or more functionalities associated with one or more wireless services, one or more functionalities associated with one or more virtual machines, one or more functionalities associated with over the top services, updates associated with the one or more functionalities associated with the dedicated customer premises equipment, updates associated with the one or more functionalities associated with the one or more video services, updates associated with the one or more functionalities associated with the one or more wireless services, updates associated with the one or more functionalities associated with the one or more virtual machines, or updates associated with the one or more functionalities associated with the over the top services.

13. The method of claim 1, further comprising:
receiving, with the computing system, a third identifier associated with the at least one customer premises equipment; and
determining, with the computing system, one or more available updates based on the third identifier associated with the customer premises equipment.

14. The method of claim 1, further comprising:
determining, with the computing system, a location of the at least one customer premises equipment.

15. The method of claim 14, wherein the location of the at least one customer premises equipment is determined when the computing system detects the at least one customer premises equipment attempting to connect to a network or when the computing system detects the at least customer premises equipment has been powered up.

16. The method of claim 14, further comprising:
sending, with the computing system, a request to a user device to confirm that the at least one customer premises equipment is disposed at the location; and
wherein sending, with the computing system and via the portal, one or more updates to each of the at least one customer premises equipment comprises sending, with the computing system, the one or more updates to the at least one customer premises equipment, in response to receiving a confirmation of the location associated with the at least one customer premises equipment.

17. The method of claim 16, wherein the request comprises at least one of an email, a text message, or a voice call.

18. The method of claim 16, wherein the user device comprises at least one of a desktop computer associated with the user, a laptop computer associated with the user, a tablet computer associated with the user, a smart phone associated with the user, a cellphone associated with the user, a personal digital assistant associated with the user, a remote-control device associated with the user, or a portable gaming device associated with the user.

19. An apparatus, comprising:
at least one processor; and
a non-transitory computer readable medium communicatively coupled to the at least one processor, the non-transitory computer readable medium having stored thereon computer software comprising a set of instructions that, when executed by the at least one processor, causes the apparatus to:
receive a first identifier associated with at least one service;
access a portal associated with the first identifier that is associated with the at least one service;
receive, via the portal, a second identifier associated with a user who is requesting, from a service provider, service via one or more of at least one customer premises equipment or a user device;
verify, via the portal, the second identifier associated with the user; and
in response to the user providing the second identifier via the portal and the portal verifying the provided second identifier, send, via the portal, one or more updates to the at least one customer premises equipment, based at least in part on one or more of the first identifier associated with the at least one service and the second identifier associated with the user.

20. A system, comprising:
a computing system, comprising:
at least one first processor; and
a first non-transitory computer readable medium communicatively coupled to the at least one first processor, the first non-transitory computer readable medium having stored thereon computer software comprising a first set of instructions that, when executed by the at least one first processor, causes the computing system to:
receive a first identifier associated with at least one service;
access a portal associated with the first identifier that is associated with the at least one service;
receive via the portal, a second identifier associated with a user who is requesting, from a service provider, service via one or more of at least one customer premises equipment or a user device;
verify, via the portal, the second identifier associated with the user; and
in response to the user providing the second identifier via the portal and the portal verifying the provided second identifier, send, via the portal, one or more updates to the at least one customer premises equipment, based at least in part on one or more of the first identifier associated with the at least one service and the second identifier associated with the user.
